(19) United States
(12) Patent Application Publication
(10) Pub. No.: US 2020/0039688 A1
(43) Pub. Date: Feb. 6, 2020

(54) PALLETISED CONTAINER ASSEMBLIES AND CONTAINERS FOR USE THEREIN

(71) Applicant: POLYKEG S.R.L., Bergamo (IT)

(72) Inventors: Sergio SONZOGNI, Grassobbio (IT); Philip Andrew WALTON, Bishop Auckland Durham (GB)

(21) Appl. No.: 16/485,906

(22) PCT Filed: Feb. 22, 2018
(86) PCT No.: PCT/GB2018/050459

§ 371 Date: Aug. 14, 2019

(30) Foreign Application Priority Data
Feb. 23, 2017 (GB) 1702971.1

(51) Int. Cl. B65D 21/02; B65D 8/00; B67D 1/08; B65D 71/00

(52) U.S. Cl. CPC B65D 21/0202; B65D 7/045; B65D 11/06; B65D 2571/00018; B67D 1/0801; B67D 1/0889; B65D 71/0096; B65D 21/0204

(57) ABSTRACT

A palletised container assembly includes a pallet providing a base, and a group of containers (1) are arranged and supported on the pallet with a wrapping band stretched around the containers to hold them together. Each of the containers has a container (body 2), two chimes (3), (4) secured to the top and bottom ends of the container body, and a valve assembly (8) which incorporates a draw tube (8a) extending within the container body. Each chime has a substantially circular peripheral outer wall (9), (10) which, at its widest point, is provided with a series of circumferentially-spaced projections (15) which engage the projections of adjacent containers to restrict relative movement between the containers in transit.

### TECHNICAL FIELD OF THE INVENTION

This invention relates to palletised container assemblies generally, and more particularly to the containers used in such assemblies.

### BACKGROUND

Wooden pallets are often used to transport a variety of goods from one place to another. Pallets therefore come in various shapes and sizes. When used to transport containers holding beer, fruit juices or other liquids the containers may be loaded on the pallet in one or more layers. In order to maximise the number of containers on the pallet they are usually loaded in a particular pattern with mutual side contact and with minimum overhang at the pallet edges. The group of containers is then “stretch wrapped” by placing a band of extensible material around the sides of the containers under tension, which is intended to hold the containers in the original pattern. Although this effectively holds the containers during general handling, prolonged vibration in transit may cause the containers to slip against each other so that the shape of the pattern is lost. In FIG. 1 the arrows labeled A and B show the movement which can typically take place resulting in the containers overhanging at one end by a distance C. When the containers end up protruding beyond the edges of the pallet the overhanging containers are more subject to damage and handling of the stacked pallets becomes more difficult.

One existing solution to this problem is to provide each of the containers with a top chime with an octagonal peripheral shape. Thus, in addition to their usual function of facilitating general lifting and handling of the individual containers, when the containers are palletised the chimes locate the containers in a regular grid of perpendicular rows, and the wrapped containers are therefore unable to move relative to each other. Although this known solution is very good at preventing movement in transit it increases the time taken to load the pallets as the containers must all be carefully aligned. Also, since there is only one predetermined regular pattern in which the containers can be arranged on a pallet their positions cannot be adjusted to make optimum use of the available space. There may be a considerable amount of waste space around the edges of each pallet, which considerably increases transportation costs over a large number of container movements.

### SUMMARY OF THE INVENTION

When viewed from one aspect the present invention is concerned with a palletised container assembly which includes a pallet to provide a base. In an embodiment the palletised container assembly includes a plurality of containers arranged and supported on the pallet.

In an embodiment each of the containers includes a container body and a chime secured thereto. In an embodiment he container body has a top wall, and a valve assembly is mounted in the top wall. In an embodiment the valve assembly incorporates a draw tube extending within the container body. In an embodiment the chime has a substantially circular peripheral outer wall.

In an embodiment a wrapping band is stretched around the containers to hold them together on the pallet.

In an embodiment each substantially circular peripheral outer wall is provided with a plurality of circumferentially-spaced projections which engage the said projections of adjacent containers to restrict relative movement between the containers.

The invention also provides a container including a container provided with such circumferentially-spaced projections.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a plan view showing the typical movement of twelve prior art containers following transportation on a pallet;

FIG. 2 is a general view of a modified container;

FIG. 3 is a top plan view of the container;

FIG. 4 is a detail of a top chime of the container;

FIG. 5 is a plan view of four such containers stood side-by-side in mutual contact; and

FIG. 6 is a plan view showing twelve of the containers arranged on a pallet for transportation.

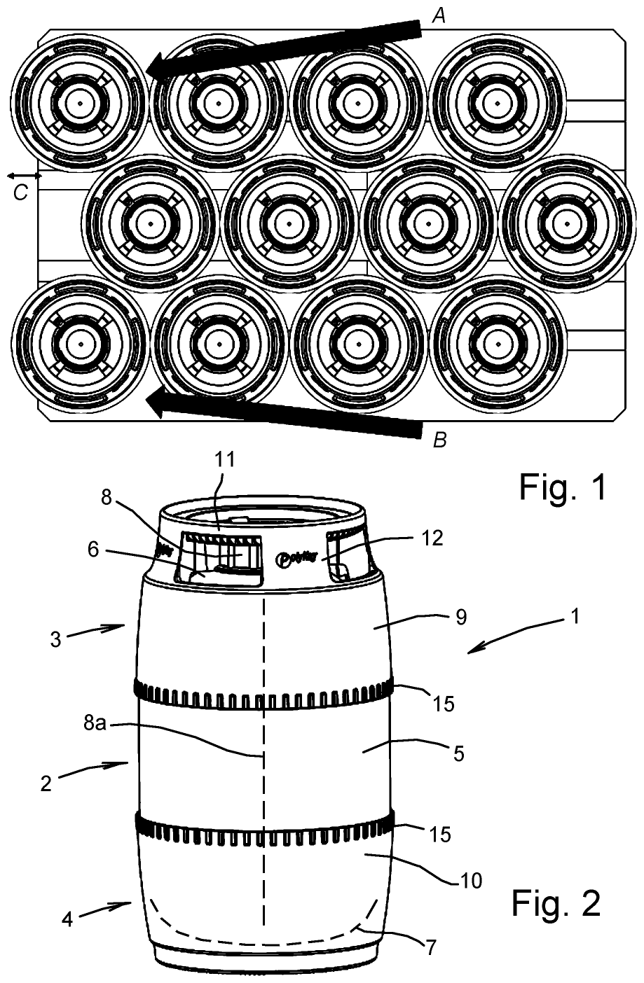

### DETAILED DESCRIPTION OF THE DRAWINGS

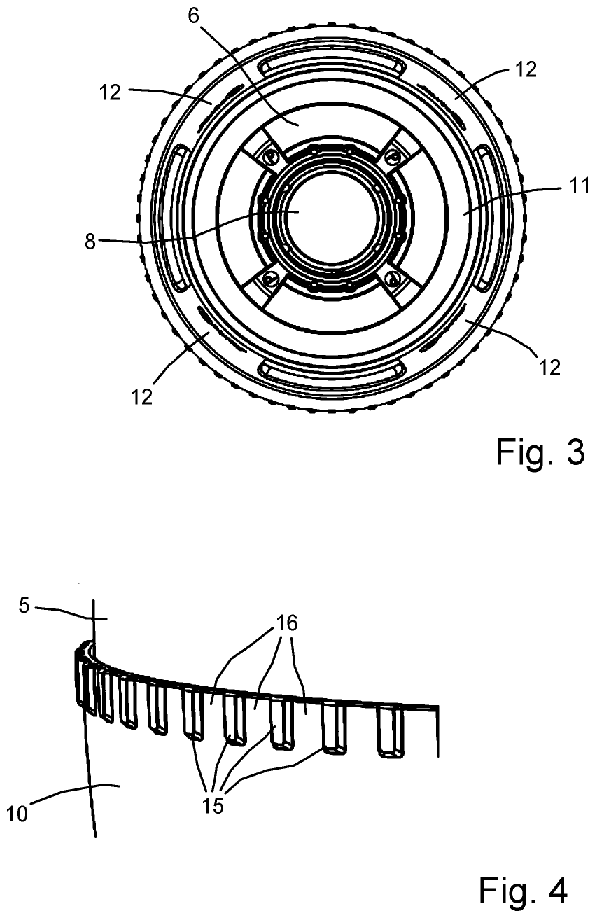

Referring to FIG. 2, a container 1 is formed of polymers suitable for holding a potable liquid such as beer, fruit juices etc. The container has a container body 2, a top chime 3, which facilitates general handling of the container, and a bottom chime 4 which provides a base for the container body. The container body 2 is preferably formed in one piece, e.g. by blow moulding, and includes a generally cylindrical side wall 5 of circular cross-section, a domed top wall 6, and a domed bottom wall 7 which is enclosed within the bottom chime 4. The top wall 6 has a central neck to receive a valve assembly 8—see FIG. 3 also—which incorporates a draw tube 8a through which liquid can be withdrawn from the bottom of the container body. When the valve assembly 8 is not engaged by a suitable fitting it sealably closes under spring pressure to prevent loss of the container contents. The top and bottom chimes 3 and 4 are relatively rigid and may be formed by injection moulding. Each chime 3, 4 has a substantially circular peripheral outer wall, 9 and 10 respectively, which both embrace portions of the side wall 5. The top chime 3 has an inset ring-shaped handle 11 which is supported above the peripheral outer wall 9 by integral arms 12. The two chimes are secured to the container body 2, e.g. using a suitable adhesive, moulded interlocking formations, a clip arrangement etc.

At their widest part, nearest to the middle of the container, the peripheral outer wall 9, 10 of each chime is provided with circumferentially-spaced projections 15. Although the shape and pitch of the projections 15 may vary, in this embodiment, as best seen in FIG. 4, the projections take the form of short, axially extending ribs or teeth (as with gear teeth) which are circumferentially spaced apart by gaps 16 of approximately twice the circumferential width of the teeth.

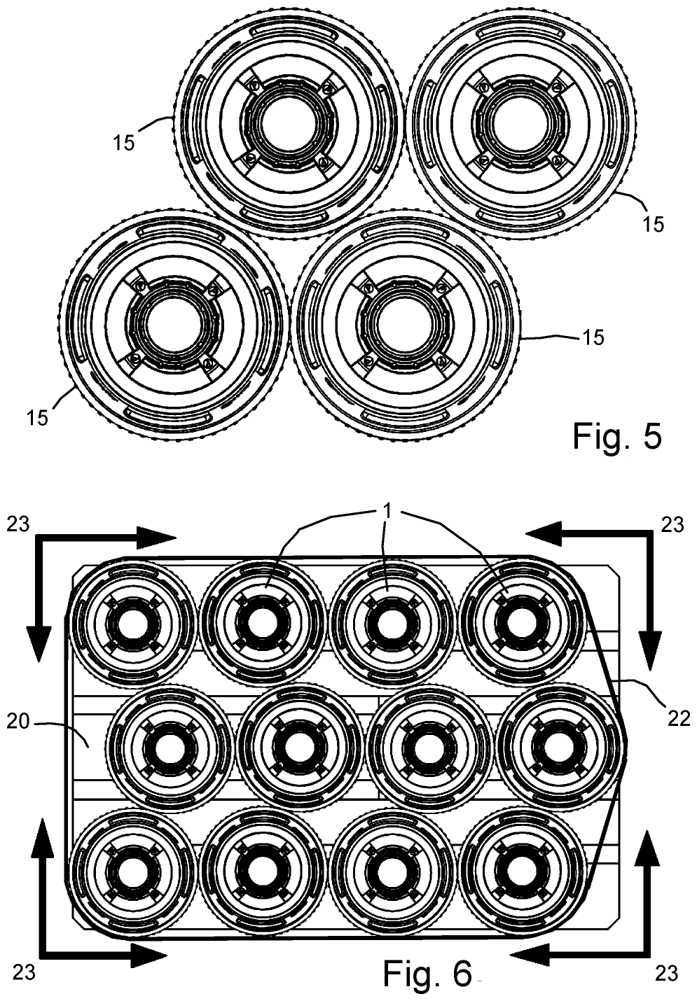

When the containers are stood side-by-side in mutual contact as shown in FIG. 5 the projecting ribs or teeth 15 engage the projections 15 of adjacent containers to prevent relative rotation between the containers. FIG. 6 shows twelve such containers arranged on a rectangular wooden pallet 20 in a configuration which provides an acceptable minimal overhang at all four sides of the pallet. It will be noted that each container is in mutual contact with at least two adjacent containers, which reduces the risk of relative movement. Once the containers have been loaded onto the pallet a band of resilient plastic film 22 is wound around the outside of the containers, as indicated by the arrows 23, so that the band is stretched and held under tension to ensure that the containers are held together and the projections 15 cannot become disengaged from each other. The interlocking ribs or teeth 15 thus prevent the containers from slipping or rotating relative to one another so that the pattern of containers remains stable during in-transit vibration.

Clearly the number of containers loaded onto a pallet will depend on their size and on the size and shape of the pallet, but the best configuration to achieve the maximum number of containers with little or no overhang is generally easy to determine.

The circumferential gaps 16 between the ribs need to be larger than the circumferential width of the teeth as this helps the teeth to engage during loading onto the pallet without the need for precise alignment. However, should the teeth fail to mesh during initial palletisation they soon become interlocked when subjected to minimal vibration during transportation. The containers are therefore effectively self-locating.

The circumferential dimension of the projections 15 should be large enough to provide sufficient sheer strength to withstand the lateral loads to which they are normally subjected. Their axial dimension should also be large enough to ensure that the ribs or teeth cannot become disengaged if the containers are subject to vertical shaking. A ratio of axial length to circumferential width is preferably greater than 1:1 and no more than 5:1. The distance by which the projections are required to protrude in a radial direction to ensure continued engagement is relatively small and may be similar to the circumferential width of the teeth. This does not therefore significantly increase the overall diameter of the container.

The projections will still work effectively if they are only provided on one chime. In some embodiments the bottom chime may be omitted and the bottom wall of the container body provided with moulded ridges in a petaloid configuration to support the container on a flat surface, as claimed in European Patent No. 2 640 646 B. Other embodiments exist in which only a bottom chime is used and the top chime is omitted. In containers with two chimes however, it is generally preferred to provide the interlocking projections on both chimes since this increases the chances of interlocking if any of the containers are not perfectly vertical or are slightly deformed for any reason.

Whilst the above description places emphasis on the areas which are believed to be new and addresses specific problems which have been identified, it is intended that the features disclosed herein may be used in any combination which is capable of providing a new and useful advance in the art.

1. A palletised container assembly:
a pallet (20) to provide a base;
a plurality of containers (1) arranged and supported on the pallet, each of the containers including
a container body (2) having a top wall (6),
a chime (3; 4) secured to the container body and having a substantially circular peripheral outer wall (9; 10), and
a valve assembly (8) which is mounted in the top wall (6) and which incorporates a draw tube (8a) extending within the container body; and
a wrapping band (22) stretched around the containers to hold them together on the pallet;
characterised in that each substantially circular peripheral outer wall (9; 10) is provided with a plurality of circumferentially-spaced projections (15) which engage the said projections of adjacent containers to restrict relative movement between the containers.

2. A palletised container assembly according to claim 1 in which the circumferentially-spaced projections (15) are provided at the widest part of the chime.

3. A palletised container assembly according to claim 1 in which the circumferentially-spaced projections (15) are separated by circumferential gaps (16) which are greater than the circumferential width of the projections.

4. A palletised container assembly according to claim 3 in which the ratio between the circumferential gaps (16) and the circumferential width of the projections (15) is between 1.5:1 and 3:1.

5. A palletised container assembly according to claim 1 in which the axial length of the circumferentially-spaced projections (15) is greater than their circumferential width.

6. A palletised container assembly according to claim 5 in which the ratio between the axial length of the projections (15) and their circumferential width is greater than 1:1 and no more than 5:1.

7. A palletised container assembly according to claim 1 in which each container (1) has top and bottom chimes (3, 4) and both chimes are provided with a plurality of circumferentially-spaced projections (15).

8. A palletised container assembly according to claim 1 in which the container body (2) and the chime (3; 4) of each container are formed of polymer materials.

9. A container including:
a container body (2) having a top wall (6),
a chime (3; 4) secured to the container body and having a substantially circular peripheral outer wall (9; 10), and
a valve assembly (8) which is mounted on the top wall (6) and which incorporates a draw tube (8a) extending within the container body;
characterised in that the substantially circular peripheral outer wall (9; 10) is provided with a plurality of circumferentially-spaced projections (15) which are capable of engaging the said projections of adjacent containers to restrict relative movement between the containers when loaded onto a pallet.

10. A container according to claim 9 in which the circumferentially-spaced projections (15) are provided at the widest part of the chime.

11. A container according to claim 9 in which the circumferentially-spaced projections (15) are separated by circumferential gaps (16) which are greater than the circumferential width of the projections.

12. A container according to claim 11 in which the ratio between the circumferential gaps (16) and the circumferential width of the projections (15) is between 1.5:1 and 3:1.

13. A container according to claim 9 in which the axial length of the circumferentially-spaced projections (15) is greater than their circumferential width.

14. A container according to claim 13 in which the ratio between the axial length of the projections (15) and their circumferential width is greater than 1:1 and no more than 5:1.

15. A container according to claim 9 in which the container (1) has top and bottom chimes (3, 4) and both chimes are provided with a plurality of circumferentially-spaced projections (15).

16. A container according to claim 9 in which the container body (2) and the chime (3; 4) are formed of polymer materials.
